(19) United States
(12) Patent Application Publication
(10) Pub. No.: US 2006/0175002 A1
(43) Pub. Date: Aug. 10, 2006

(54) Method for applying adhesive in a controlled and precise manner

(75) Inventors: John Mobley, Lexington, TN (US); Justin Patrick Stacy, Mount Carmel, TN (US); Robert Phillips, Tullahoma, TN (US)

Correspondence Address: DAYCO PRODUCTS, LLC, 1 PRESTIGE PLACE, MIAMISBURG, OH, 45342, US

(73) Assignee: DAYCO PRODUCTS, LLC

(21) Appl. No.: 11/053,763

(22) Filed: Feb. 8, 2005

(51) Int. Cl. B29C 47/00

(52) U.S. Cl. 156/244.13

(57) ABSTRACT

A method for manufacturing a multilayer hose having reduced permeation of hydrocarbon fuel vapor, wherein the multilayer hose is useful as a hydrocarbon fuel transport hose, comprises the steps of: extruding a first fluoroelastomeric tubular structure having an inner surface and an outer surface; applying an adhesive on the outer surface of the first fluoroelastomeric tubular structure, wherein the adhesive is applied to the outer surface of the first fluoroelastomeric tubular structure using piezo electric technology comprising a piezo element disposed in an adhesive reservoir positioned at an exit end of an extruder for extruding the first fluoroelastomeric tubular structure. The adhesive reservoir comprising a plurality of nozzles equally spaced apart around the exit end of the extruder through which adhesive is discharged onto the surface of the first fluoroelastomeric tubular structure in a precise and uniform manner as the first fluoroelastomeric tubular structure exits the end of the extruder, the discharge of the adhesive being activated by application of an electric current applied to the piezo element causing the piezo element to rapidly oscillate in a precise and uniform manner causing the adhesive to be repeatedly discharged through the plurality of nozzles in a pulsating manner, whereby the adhesive is uniformly applied to the outer surface of the first fluoroelastomeric tubular structure; and extruding a second fluoroplastic tubular structure onto the first fluoroelastomeric tubular structure such that the adhesive is disposed between the first fluoroelastomeric tubular structure and the second fluoroplastic tubular structure.

### BACKGROUND OF THE INVENTION

The present invention relates generally to hoses and particularly to multilayer fuel transport hoses such as fuel filler and fuel filler neck hoses. More particularly, the invention relates to a method for applying adhesive between one or more tubular layers of a multilayer hose.

The art contains numerous examples of multi-layer tubing assemblies. For example, U.S. Pat. No. 3,561,493 to Maillard discloses tubing having two co-extruded layers of different plastics, and a co-extruded layer of adhesive therebetween. The layers are chosen from plastics having complementary properties. U.S. Pat. No. 4,643,927 to Luecke et al. shows a barrier layer is surrounded by inner and outer adhesive layers which in turn are surrounded by inner and outer surface layers of polyethylene that protect the central barrier layer from degradation. U.S. Pat. No. 4,887,647 to Igarishi et al. shows multi-layer tubing having an inner fluororubber layer that prevents degradation due to amine-type additives and also exhibits improved adhesion to an outside rubber layer. U.S. Pat. No. 5,038,833 to Brunnhofer discloses tubing having a protective outer polyamide layer, a middle alcohol barrier layer of polyvinyl-alcohol, and an inner water barrier layer of polyamide. U.S. Pat. No. 5,076,329 to Brunnhofer shows a five-layer tubing assembly having outer, inner and middle layers of nylon, and intermediate bonding and solvent-blocking layers. U.S. Pat. No. 5,639,528 to Feit et al. describes a nitrile-butadiene rubber (NBR) such as acrylonitrile-butadiene rubber as the inner tubular member and a fluoroplastic material as a barrier member around the NBR inner tubular member. While such multilayer structure prevents or slows down the permeation of hydrocarbon fuel vapor directly through the layers of the hose, a significant amount of the hydrocarbon fuel passes between the inner NBR layer and the THV barrier layer and then escapes through the ends of the hose. It is known that fluoropolymers exhibit good permeation resistance to hydrocarbon fuels. Hence, recent multilayer hose assemblies have usually included a fluoroelastomer inner tubular structure and a fluoroplastic tubular structure surrounding the inner fluoroelastomer tubular structure. However, difficulties have been encountered in adhering the fluoroelastomer tubular member to the fluoroplastic tubular member. Typically, in applying an adhesive to a first fluoropolymer surface to be adhered to a second fluoropolymer surface, the adhesive requires the presence of an organic solvent or carrier such as ethyl alcohol, toluene, etc. The carrier materials, all of which pose potential safety and/or health hazards, allow the adhesive to be effectively applied to the surface of the fluoropolymer. For example, amine adhesives are particularly effective for adhering a fluoroelastomer to a fluoroplastic, however, the carrier, which is typically ethyl alcohol, has a low flash point (55° F.) and poses a potential safety problem. Toluene has an even lower flash point of 40° F.

Accordingly, there is a need for an improved method for applying an adhesive between the various layers of multilayer fuel transport hoses that avoids potential safety hazards and is cost effective.

### SUMMARY OF THE INVENTION

The present invention is directed to a method for applying an adhesive to a substrate that is both safe and cost effective. According to the invention, a pulsating sprayer is used to apply the adhesive onto the surface of a polymeric substrate, which is to be bonded to another polymeric substrate. By using a pulsating sprayer to apply the adhesive in a precise manner, the output of adhesive can be accurately controlled; thus allowing both the amount and placement of the adhesive on the substrate to be exact. In a particular aspect of the invention, a pulsating sprayer having one or more nozzles is used to apply the adhesive around the outer surface of polymeric tubular structure. Since the adhesive is applied in such a precise manner using minute amounts of the adhesive, any safety hazards normally associated with the application of a carrier-based adhesive is eliminated. Furthermore, because the present method permits greater control over the shape and size of the adhesive being applied, the costs of applying the adhesive to a substrate can be greatly reduced. In a particularly preferred aspect of the invention, the adhesive is applied to the outside cylindrical surface of a tubular layer of a multilayer hose after the tubular layer exits the extruder. Typically, the adhesive will be applied to the surface of the tubular structure through one or mare nozzles associated with the pulsating spray applicator. Typically, the pulsating applicator will employ about 1-5 nozzles. A pulsating spray applicator having three nozzles has been found to be particularly effective to provide a sufficient and uniformly consistent coverage of adhesive on a tubular surface.

### DESCRIPTION OF THE INVENTION

Hoses, particularly, multilayer hoses, for use in the automotive industry as fuel hoses are manufactured from a plurality of tubular layers designed to provide flexibility and prevent permeation of fuel vapor and, optionally, to provide structural strength, and outer protection from the elements. Previously, such hose were constructed of a nitrile-butadiene rubber (NBR) inner tubular layer with a fluoroplastic tubular layer covering the inner NBR tubular layer. These hoses were effective in preventing permeation of hydrocarbon fuel vapor through the hose, but the inner NBR layer allowed the hydrocarbon fuel vapor to permeate through its surface where the vapor then passed between the outer surface of the NBR tube and the inner surface of the fluoroplastic tube until it permeated the environment through the end of the hose.

It became clear that, in order to prevent permeation of hydrocarbon fuel vapors from entering the atmosphere, the inner tubular member must exhibit not only the desirable characteristics of the elastomeric NBR material, but it must have greater permeability resistance than the NBR member previously used. Presently, fluoroelastomer materials are employed as the inner tubular member of the multilayer hose with a fluoroplastic member surrounding the inner fluoroelastomer member. The use of a fluoroelastomer member in place of the non-fluoroelastomer member presents a problem in that it is more difficult to adhere the two fluoropolymer to each other than to adhere the NBR member to the fluoroplastic member. Special adhesives consisting of an amine is generally applied to the inner fluoroelastomer during extrusion. Such amine adhesives require a high concentration of carrier such as ethyl alcohol (ETOH) to effectively coat inner tubular member. The problem with such amine adhesives is that, with the amount of carrier required, the adhesive becomes an extremely hazardous material to handle due to the low flash point (55° F.) of the ETOH carrier.

A method of applying an adhesive onto the surface of a fluoroelastomeric material, which may be accomplished in an effective and cost effective manner while eliminating the hazardous problems, has now been discovered. The present method comprises extruding a first tubular member of a fluoropolymer having elastomeric characteristics; applying an adhesive onto the outer surface of the fluoroelastomer tubular member as the fluoroelastomer exits the extruder head. Any of the known devices for creating pulsations in a spray pattern can be used in the present invention to create the desired pulsations in the spray applicator in delivering the adhesive in a pulsating manner. Typically, the pulsation in the spray applicator is created by a solenoid or piezo initiator. Typically, a solenoid is a cylindrical coil of insulated wire in which an axial magnetic field is established by a flow of electric current. The solenoid acts as a switch, which may be opened and closed rapidly to cause pulsations of adhesive through one or more ports. Piezo initiators are non-conducting ceramic crystals that exhibit piezoelectric properties when they become mechanically strained. A piezo crystal is somewhat like a flexible loudspeaker cone, which flexes when an electric current is applied. In accordance with the invention, an adhesive sprayer device includes a plurality of equally spaced nozzles around the extruder exit, so that the nozzles can apply a precise amount of adhesive at specific locations on the surface of the tubular member exiting the extruder. As the elastomer member exits the extruder head, the pulsating sprayer is activated by applying an electric current at a predetermined instant whereby the adhesive is discharged in a pulsating manner through the plurality of spaced apart nozzles in a precise amount onto the cylindrical surface of the fluoroelastomer member to form a uniform adhesive coating on the surface of the fluoroelastomer member. A second tubular structure comprising a fluoroplastic material is then extruded around the fluoroelastomer member to form a multilayer hose in one aspect of the present invention.

After the fluoroelastomer member is extruded, the adhesive applied thereon, and the fluoroplastic member is extruded around the fluoroelastomer member, additional polymeric layers such as a reinforcement layer and/or a protective cover layer may be applied, as desired to form a multilayer hose in another aspect of the invention. Typically, these additional layers are those known in the art to provide the desired effect.

According to the present invention, a fluoroelastomer tubular member is formed by extruding a fluoroelastomer material through an extruder. As the fluoroelastomer tubular member exits the extruder, a layer of adhesive is applied to the outer surface of the fluoroelastomer through a plurality of nozzles associated with a pulsating spraying device. This technology is currently used in the inkjet industry, but its translation to the application of an adhesive in an ETOH carrier onto an automotive fuel system hose is totally unobvious. The present process permits greater control over the shape and size of the adhesive material being applied to the outer surface of the fluoroelastomer member. Because the present method can deliver small and precisely formed amounts of adhesive with extreme accuracy, the costs of forming a multilayer hose having excellent adhesion between the layers can be kept to a minimum.

In accordance with the invention, whenever a specified amount of adhesive is required to be dispensed, a current is applied to the pulsating sprayer which forces a specified amount of adhesive out of the nozzle(s) and onto the surface of the inner tubular member.

While any number of nozzles can be used to dispense the adhesive, it is generally desirable to employ a plurality of such nozzles to provide a uniform coating of adhesive on the outer tubular surface. Generally, up to five evenly spaced nozzles are sufficient to provide a uniform coating of adhesive having the desired thickness. Application of an adhesive onto the outer surface of an extruded fluoroelastomer tubular structure for the formation of in inner tubular member of a fuel transport hose using three spaced apart nozzles has been found to be particularly effective to apply a sufficient amount of adhesive onto the surface of the tubular structure.

The elastomeric material, which forms the inner tubular structure of the hose of the present invention, is an FKM fluoroelastomer. FKM fluoroelastomers are commonly known as fluoroelastomers or fluororubbers of the polymethylene type that utilizes vinylidene fluoride as a co-monomer and has substituent fluoro, alkyl, perfluoro or perfluoroalkoxy groups on the polymer chain with or without a cure site. Generally, FKM fluoroelastomers include dipolymers of hexafluoropropylene and vinylidene fluoride; terpolymers of tetrafluoroethylene, hexafluoropropylene, and vinylidene fluoride; terpolymers of tetrafluoroethylene, a fluorinated vinyl ether and vinylidene fluoride; terpolymers of tetrafluoroethylene, propylene and vinylidene fluoride; and pentapolymers of tetrafluoroethylene, hexafluoropropylene, vinylidene fluoride, ethylene and a fluorinated vinyl ether.

The fluoroplastic tubular member is a fluoropolymer, which exhibits thermoplastic characteristics. Typically, the fluoroplastic member is a tetrafluoroethylene-hexafluoropropylene-vinylidene fluoride (THV) terpolymer. Fluoroplastic terpolymers available from Dyneon under the name THV 200, THV 300, THV 400 and THV 500 may be employed to form the fluoroplastic tubular member of the present invention.

The adhesives useful in the present method to adhere the various fluoropolymer layers together are those commonly known in the art to adhere such fluoropolymers together. However, adhesives in combination with an organic solvent or carrier are neither contemplated nor desired. Preferably, the adhesive is an amine or an acrylic compound. The amine can be an aliphatic di- or polyamine of any molecular weight that, when used, will result in an improvement in the adhesive bond strength between appropriate layers of the multilayer hose. Examples of such amines include N[3-(trimethoxysilyl)propyl]methane amine, polyallylamine, and the like. An example of the acrylic compound is Vamac, an ethylene acrylic elastomer compound available from du Pont.

The adhesive used in the present invention to adhere the fluoroelastomer tubular member to the fluoroplastic tubular member and the piezo technology used to apply the adhesive, may be used to adhere any of the other layers together.

The optional reinforcement layer includes reinforcing material such as natural or synthetic fibers, e.g., nylon fibers, rayon fibers, polyester fibers, cotton fibers, glass fibers, carbon fibers, and the like as well as metal wire.

The optional outer cover of the hose is a protective layer of any commercially recognized materials for such use such as styrene-butadiene rubber, chlorinated polyethylene, chlorosulfonated polyethylene, vinylethylene-acrylic rubber, acrylic rubber, epichlorohydrin rubber, polychloroprene rubber, polyvinyl chloride, ethylene-propylene rubber, ethylene-propylene-diene rubber, ultra high molecular weight polyethylene, high density polyethylene, nylon, and the like.

In carrying out the present invention, it is further contemplated to use any of the known additives, which are particularly useful in providing desirable characteristics to the various tubular members. For example, it is known in the art to employ a conductive agent such as carbon black in the inner tubular member to dissipate the electrical charges built up by flowing fluids. Other desirable additives include crosslinking agents, plasticizers, stabilizers, flame retardants, pigments, antioxidants, calcium hydroxide, magnesium hydroxide, antimony oxide, and the like. The amounts of such additives are those commonly used in the prior art to manufacture fuel transport hoses.

While certain aspects of the invention have been fully described, it will be obvious that certain other changes and modifications may be made thereto without departing from the spirit and scope of the invention.

What is claimed is:

1. A method for manufacturing a multilayer hose having reduced permeation of: hydrocarbon fuel vapor, wherein said multilayer hose is useful as a hydrocarbon fuel transport hose, said method comprising the steps of:
extruding a first tubular structure having an inner surface and an outer surface, said tubular structure comprising a fluoropolymer exhibiting elastomeric characteristics;
applying an adhesive on the outer surface of said first tubular structure, wherein said adhesive is applied to the outer surface of said first tubular structure by a pulsating sprayer which comprises a pulsating initiator, said pulsating initiator being activated by an electric current to cause a pulsating action, said pulsating sprayer positioned at an exit end of an extruder for extruding said first tubular structure, said pulsating sprayer further comprising a plurality of nozzles equally spaced around the exit end of said extruder through which adhesive is discharged onto the surface of said first tubular structure in a precise and uniform coating as said first tubular structure exits the end of said extruder, the discharge of said adhesive being activated by application of an electric current applied to said pulsating initiator causing said adhesive to be precisely discharged through said plurality of nozzles in a pulsating manner, whereby the adhesive is uniformly and precisely applied to the outer surface of said first tubular structure; and
extruding a second tubular structure onto said first tubular structure such that said adhesive is disposed between said first tubular structure and said second tubular structure.

2. The method of claim 1 wherein said first tubular structure comprises a fluoroelastomer selected from the group consisting of dipolymers of hexafluoropropylene and vinylidene fluoride; terpolymers of tetrafluoroethylene, hexafluoropropylene, and vinylidene fluoride; terpolymers of tetrafluoroethylene, a fluorinated vinyl ether and vinylidene fluoride; terpolymers of tetrafluoroethylene, propylene and vinylidene fluoride; and pentapolymers of tetrafluoroethylene, hexafluoropropylene, vinylidene fluoride, ethylene and a fluorinated vinyl ether.

3. The method of claim 1 wherein said second tubular structure comprises a tetrafluoroethylene-hexafluoropropylene-vinylidene fluoride (THV) terpolymer.

4. The method of claim 1 where said adhesive is an amine or an acrylic compound.

5. The method of claim 4 wherein said adhesive is a di- or polyamine selected from the group consisting of N[3-(trimethoxysilyl)propyl]methane amine and polyallylamine.

6. The method of claim 4 wherein said adhesive is an ethylene-acrylic elastomer.

7. The method of claim 1 further including the step of applying a reinforcing layer to said multilayer hose.

8. The method of claim 7 wherein said reinforcing layer comprises a reinforcement material selected from the group consisting of nylon fibers, rayon fibers, polyester fibers, cotton fibers, glass fibers, carbon fibers, and metal wire.

9. The method of claim 1 further including the step of applying a protective cover layer to said multilayer hose.

10. The method of claim 9 wherein said protective cover layer is selected from the group consisting of styrene-butadiene rubber, chlorinated polyethylene, chlorosulfonated polyethylene, vinylethylene-acrylic rubber, acrylic rubber, epichlorohydrin rubber, polychloroprene rubber, polyvinyl chloride, ethylene-propylene rubber, ethylene-propylene-diene rubber, ultra high molecular weight polyethylene, high density polyethylene and nylon.

11. The method of claim 1 wherein said pulsating initiator is a piezo electric crystal.

12. The method of claim 1 wherein said pulsating device is a solenoid switch.

13. The method of claim 11 wherein said piezo electric crystal is activated by an electric current causing said piezo electric crystal to oscillate rapidly by flexing in one direction to discharge said adhesive from said pulsating device and then flexing in the opposite direction to replenish adhesive in said pulsating device.

14. The method of claim 12 wherein said solenoid switch is activated by an electric current causing said solenoid switch to open and close rapidly to discharge said adhesive from said pulsating sprayer in a pulsating manner.

15. The method of claim 1 wherein said plurality of nozzles comprises about 1-5 nozzles equally spaced around the outer surface of first tubular structure.

16. In a method for manufacturing a multilayer fuel transport hose, said method comprising the steps of:
extruding a first tubular structure having an inner surface and an outer surface, said tubular structure comprising a fluoropolymer exhibiting elastomeric characterics;
applying an adhesive on the outer surface of said first tubular structure, and
extruding a second tubular structure onto said first tubular structure such that said adhesive is disposed between said first tubular structure and said second tubular structure, the improvement wherein said adhesive is applied to the outer surface of said first tubular structure using a pulsating sprayer comprising a pulsating initiator for applying said adhesive to the outer surface of said tubular structure in a pulsating manner.

17. The method of claim 16 wherein said pulsating initiator is a piezo electric crystal disposed in an adhesive reservoir, said pulsating sprayer further comprising a plurality of nozzles equally spaced apart around the exit end of said extruder through which adhesive is discharged onto-the surface of said first tubular structure in a precise and uniform coating as said first tubular structure exits the end of said extruder, the discharge of said adhesive being activated by application of an electric current applied to said piezo crystal causing said piezo crystal to rapidly oscillate in a precise and uniform manner forcing said adhesive to be discharged through said plurality of nozzles in a pulsating manner, whereby the adhesive is uniformly and precisely applied to the outer surface of said first tubular structure.

18. The method of claim 16 wherein said pulsating device is a solenoid switch disposed in said pulsating sprayer wherein said solenoid switch is activated by application of an electric current applied to said solenoid switch causing said solenoid switch to rapidly open and close in a precise and uniform manner forcing said adhesive to be discharged through said plurality of nozzles in a pulsating manner, whereby the adhesive is uniformly applied to the outer surface of said first tubular structure.

19. The method of claim 16 wherein said plurality of nozzles comprises about 1-5 nozzles equally spaced around the outer surface of said first polymeric structure.

20. The method of claim 16 wherein said first tubular structure comprises a fluoroelastomer selected from the group consisting of dipolymers of hexafluoropropylene and vinylidene fluoride; terpolymers of tetrafluoroethylene, hexafluoropropylene, and vinylidene fluoride; terpolymers of tetrafluoroethylene, a fluorinated vinyl ether and vinylidene fluoride; terpolymers of tetrafluoroethylene, propylene and vinylidene fluoride; and pentapolymers of tetrafluoroethylene, hexafluoropropylene, vinylidene fluoride, ethylene and a fluorinated vinyl ether; said second tubular structure comprises a tetrafluoroethylene-hexafluoropropylene-vinylidene fluoride (THV) terpolymer; and said adhesive is an amine or an acrylic compound.

21. A method of adhering a first polymeric substrate to a second polymeric substrate, said method comprising the steps of:
providing a first polymeric substrate;
applying an adhesive to a surface of said first polymeric substrate using a pulsating sprayer comprising a pulsating initiator to apply said adhesive to polymeric substrate in a pulsating manner using a piezo electric crystal, said pulsating sprayer further comprising a plurality of nozzles equally spaced apart at the surface of said polymeric substrate, through which adhesive is discharged onto the surface of said first polymeric substrate in a precise and uniform coating, the discharge of said adhesive being initiated by application of an electric current applied to said piezo crystal causing said piezo crystal to oscillate rapidly forcing said adhesive through said plurality of nozzles in a pulsating manner, whereby the adhesive is uniformly and precisely applied to the outer surface of said first polymeric substrate; and
providing a second polymeric substrate onto said first polymeric substrate such that said adhesive is disposed between said first polymeric substrate and said second polymeric substrate.

22. The method of claim 21 wherein said first tubular structure comprises a fluoroelastomer selected from the group consisting of dipolymers of hexafluoropropylene and vinylidene fluoride; terpolymers of tetrafluoroethylene, hexafluoropropylene, and vinylidene fluoride; terpolymers of tetrafluoroethylene, a fluorinated vinyl ether and vinylidene fluoride; terpolymers of tetrafluoroethylene, propylene and vinylidene fluoride; and pentapolymers of tetrafluoroethylene, hexafluoropropylene, vinylidene fluoride, ethylene and a fluorinated vinyl ether; said second tubular structure comprises a tetrafluoroethylene-hexafluoropropylene-vinylidene fluoride (THV) terpolymer; and said adhesive is an amine or an acrylic compound.

23. A method of adhering a first polymeric substrate to a second polymeric substrate, said method comprising the steps of:
providing a first polymeric substrate;
applying an adhesive to a surface of said first polymeric substrate using a pulsating sprayer comprising a pulsating initiator to apply said adhesive to polymeric substrate in a pulsating manner using a solenoid switch, said pulsating sprayer further comprising a plurality of nozzles equally spaced apart at the surface of said polymeric substrate, through which adhesive is discharged onto the surface of said first polymeric substrate in a precise and uniform coating, the discharge of said adhesive being initiated by application of an electric current applied to said solenoid switch causing said solenoid switch to alternately open and close rapidly a plurality of nozzles, forcing said adhesive through said plurality of nozzles in a pulsating manner, whereby the adhesive is uniformly and precisely applied to the outer surface of said first polymeric substrate; and
providing a second polymeric substrate onto said first polymeric substrate such that said adhesive is disposed between said first polymeric substrate and said second polymeric substrate.

24. The method of claim 17 where said wherein said first tubular structure comprises a fluoroelastomer selected from the group consisting of dipolymers of hexafluoropropylene and vinylidene fluoride; terpolymers of tetrafluoroethylene, hexafluoropropylene, and vinylidene fluoride; terpolymers of tetrafluoroethylene, a fluorinated vinyl ether and vinylidene fluoride; terpolymers of tetrafluoroethylene, propylene and vinylidene fluoride; and pentapolymers of tetrafluoroethylene, hexafluoropropylene, vinylidene fluoride, ethylene and a fluorinated vinyl ether; said second tubular structure comprises a tetrafluoroethylene-hexafluoropropylene-vinylidene fluoride (THV) terpolymer; and said adhesive is an amine or an acrylic compound.
